(19) United States
(12) Patent Application Publication
(10) Pub. No.: US 2018/0297795 A1
(43) Pub. Date: Oct. 18, 2018

(54) EXTENDABLE MOVABLE PLATFORM AND ATTACHMENT

(71) Applicant: Innovative Logistics, Inc., Little Rock, AR (US)

(72) Inventors: Stonie Hopkins, Little Rock, AR (US); Jefferson Maldonado, Little Rock, AR (US); Dylan Henderson, Fort Smith, AR (US)

(21) Appl. No.: 15/953,931

(22) Filed: Apr. 16, 2018

Related U.S. Application Data
(60) Provisional application No. 62/485,657, filed on Apr. 14, 2017.

(51) Int. Cl. B65G 63/00; B65G 63/02

(52) U.S. Cl. CPC B65G 63/002; B65G 63/022

(57) ABSTRACT

Disclosed herein is a movable platform and an extension assembly which enables the width or length of the movable platform to be extended. The extension assembly comprises a plurality of clips which releasably engage openings on the movable platform. A top surface of the extension assembly is flush with a top surface of the movable platform.

### CROSS-REFERENCE TO RELATED APPLICATIONS

This application claims priority to U.S. Provisional Application Ser. No. 62/485,657, filed Apr. 14, 2017, the entire contents of which are hereby incorporated by reference in their entirety.

### Related Applications

The present invention can be utilized in any standard or custom warehouse. Particularly, the MP of the present invention can be utilized with the systems and methods described in related U.S. Pat. No. 9,367,827, issued Jun. 14, 2016 and U.S. patent application Ser. No. 15/798,729, filed Oct. 31, 2017.

### FIELD OF THE INVENTION

The present invention provides a movable platform (MP) used to transfer freight in and out of a semi-trailer in one move. More particularly, the present invention provides a mobile MP that can be maneuvered through a warehouse having a forklift attachment.

### BACKGROUND

The trucking industry, specifically the segment consisting of Full-Truckload (FLT) and Less-than-truckload (LTL), is a segment of the shipping industry that ships a wide array of freight. The shipment sizes can vary from an individual item consisting of one piece to a full truckload consisting of several pieces. FTL freight is typically handled only once as it is loaded into a semi-trailer at the shipper's location and unloaded at the consignee's location. In the LTL industry, freight is commonly handled multiple times, with the shipper loading the freight into a semi-trailer, then the freight is returned to a local freight terminal to be unloaded/loaded into a another trailer to be routed to the destination. This process, commonly known as a hub-and-spoke network, is used to increase the efficiency of the operation by increasing density.

The traditional method of loading freight into a semi-trailer is to back a semi-trailer to a raised dock and unload each piece/pallet using a forklift. A 53′ semi-trailer pan can hold up to 30 pallets on the floor of the trailer. To unload a loaded semi-trailer conventionally, it requires a single forklift driver to drive into the trailer to pick-up and remove each pallet. During this unloading process, a driver could take up to 30 trips into the trailer to remove each pallet. This process is typically completed utilizing 1 forklift driver but it is possible to utilize 2 forklift drivers to unload a trailer simultaneously.

As should be apparent, this process is wasteful in that the forklift is often not conveying cargo (empty carries). Also, because the trailer is no connected to the dock, the forklift driver must be careful each time that they enter the trailer. This further reduces the speed of the process. Therefore, there is clearly a need for a movable platform which can be easily unloaded from a trailer in a single move without the forklift driver having to enter the trailer. As will be made apparent in the following disclosure, the present invention provides a solution for these aforementioned problems.

### SUMMARY

Disclosed herein is a movable platform and an extension assembly which enables the width or length of the movable platform to be extended. The extension assembly comprises a plurality of clips which releasably engage openings on the movable platform. A top surface of the extension assembly is flush with a top surface of the movable platform.

### BRIEF DESCRIPTION OF THE DRAWINGS

These and other advantages of the present invention will be readily understood with the reference to the following specifications and attached drawings wherein:

FIG. 1 depicts a perspective view of the movable platform.

FIG. 1A depicts an alternate embodiment of the movable platform.

FIG. 2 depicts a perspective view of the frame in isolation.

FIG. 2A depicts a perspective view of the frame of the movable platform of FIG. 1A in isolation.

FIG. 3 depicts a perspective view of the mechanical actuation assembly inserted into a cutaway portion of the frame.

FIG. 4 depicts various views of the drawbar in isolation.

FIG. 5 depicts various views of the connection plate in isolation.

FIG. 6 depicts a perspective view of a single ramp guide in isolation.

FIG. 7 depicts a perspective view of a single ramp block in isolation.

FIG. 8 depicts a cutaway front perspective view of the mechanical actuation assembly.

FIG. 9 depicts a perspective view of the movable platform with the decking removed.

FIG. 10 depicts a perspective view of the mechanical actuation assembly in an engaged position.

FIG. 11 depicts a side view of the MP showing the rollers extended.

FIGS. 12-15 depict the forklift attachment for use with the MP.

FIGS. 16-17 depict the forklift attachment with the pushing hydraulic cylinders extended.

FIGS. 18-19 depict the forklift attachment with the casters extended.

FIG. 20 depicts the forklift attachment connected to the MP.

FIG. 21 depicts the forklift attachment secured to a forklift.

FIG. 22 depicts a rear view of the forklift attachment with tines inserted.

FIGS. 23-32 depict an alternate embodiment of the forklift attachment.

FIGS. 33-38 depict various MP extension concepts.

FIGS. 39-41B depict schematics for a Mobile Platform Collision Avoidance system.

### DETAILED DESCRIPTION

Preferred embodiments of the present invention will be described herein below with reference to the accompanying drawings. In the following description, well-known functions or constructions are not described in detail because they may obscure the invention in unnecessary detail. While the present invention is generally directed to LTL operations for use in the trucking industry, the teachings may be applied to other shipping industries, just as those by air, sea, and rail. Therefore, the teachings should not be constructed as being limited to only the trucking industry.

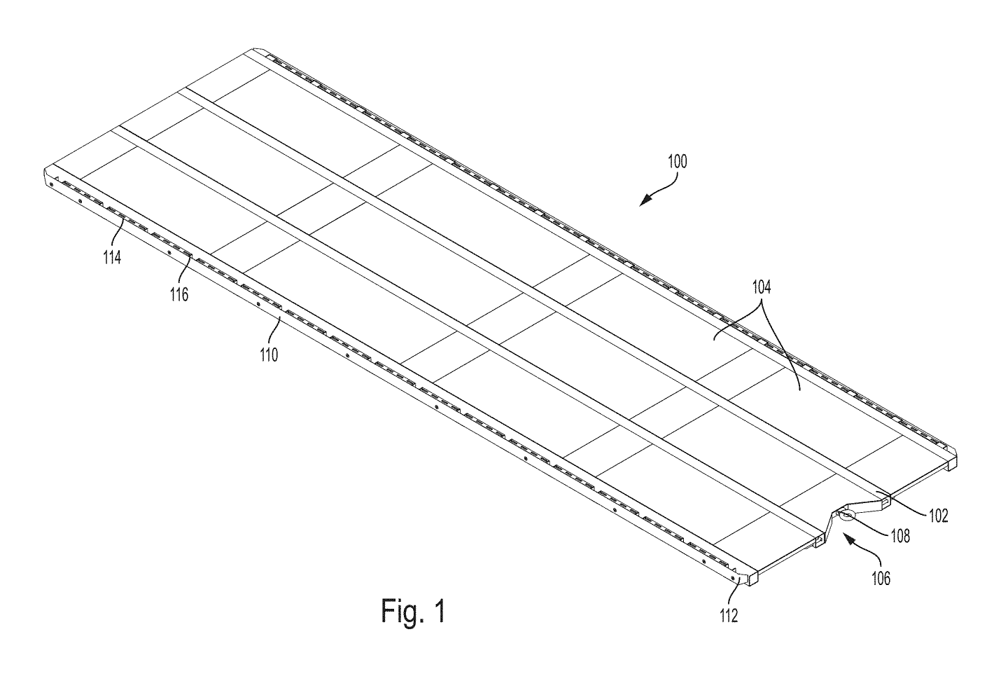

Referring first to FIG. 1, depicted is a perspective view of movable platform (MP) 100 used to convey freight in and out of trailers. Generally, MP 100 comprises frame 102, decking 104, and mechanical actuation assembly 106. MP 100 preferably has a height of 4″ or less when resting on the ground and 5″ or less when rollers are engaged to limit impact on load capacity in a trailer. NIP 100 is designed to be loaded with up to 24,000 pounds of freight. MP 100 can be raised without the forklift operator getting off the forklift via the forklift attachment and vice versa. MP 100 is designed to be conveyed with a standard 4,000 pound capacity forklift to unload/load MP 100 in and out of a trailer.

Empty MPs 100 can be stacked up to 8 high in a pup trailer, allowing more economical shipping from the manufacturer or for repositioning of MPs from on hub/spoke to another. Generally, MP 100 is 26′ in length, allowing it to fit into a standard pup trailer which has an interior length of 27.5′ or two into a van trailer which has an interior length of 52.5′. Preferably, the width of MP 100 can be modified to fit either a roll door trailer or a swing door trailer. It should be apparent to one of ordinary skill in the art that these dimensions can be modified to fit any global standard of trailer or for any custom trailer.

Frame 102 provides the structural support for MP 100. Frame 102 is constructed from rectangular or square tubular segments which are welded together to form frame 102. Decking 104 is preferably a lightweight material, such as plywood or plastic, which prevents smaller freight from falling through frame 102 when MP 100 is in transport. The frame 102 and decking 104 is designed to allow a standard 4,000 lb. forklift to drive on the platform to unload/load freight conventionally. It should be apparent that decking 104 may also be a metal mesh or other material if weight of MP 100 is a priority.

Mechanical actuation assembly 106, which will be described in more detail later, is used to raise or lower the rollers of MP 100 by exerting a lateral pulling force on lunette eye 108. The majority of mechanical actuation assembly 106 resides within MP 100 and only lunette eye 108 is usually visible.

In some embodiments, frame 102 further comprises nib rail 110 located along the opposing lengthwise edges of frame 102. Each edge 112 of each rub rail 110 is chamfered at an angle (e.g., 45°) which allows for easier loading and unloading of MP 100 by helping to guide MP 100 into and out of a trailer. Rub rail 110 is preferably a ¼″ plate raised above the decking 104 which helps to release MP 100 from forklift blades and to prevent freight from shifting. The outside edge of deck 102 may also comprise stake pockets 116 or cut outs 114 for securing freight to movable platform 100 with straps or webbing.

An alternate embodiment of MP 100 is depicted in FIG. 1A. In this embodiment, a rear portion of MP 100 contains fixed lunette eye 118 in a recess which is used to convey the MP 100 with a forklift attachment after the rollers have been raised using the mechanical actuation assembly. Also, if MP 100 is moved by an AGV, both ends of MP 100 can be guided using lunettes 108 and 118.

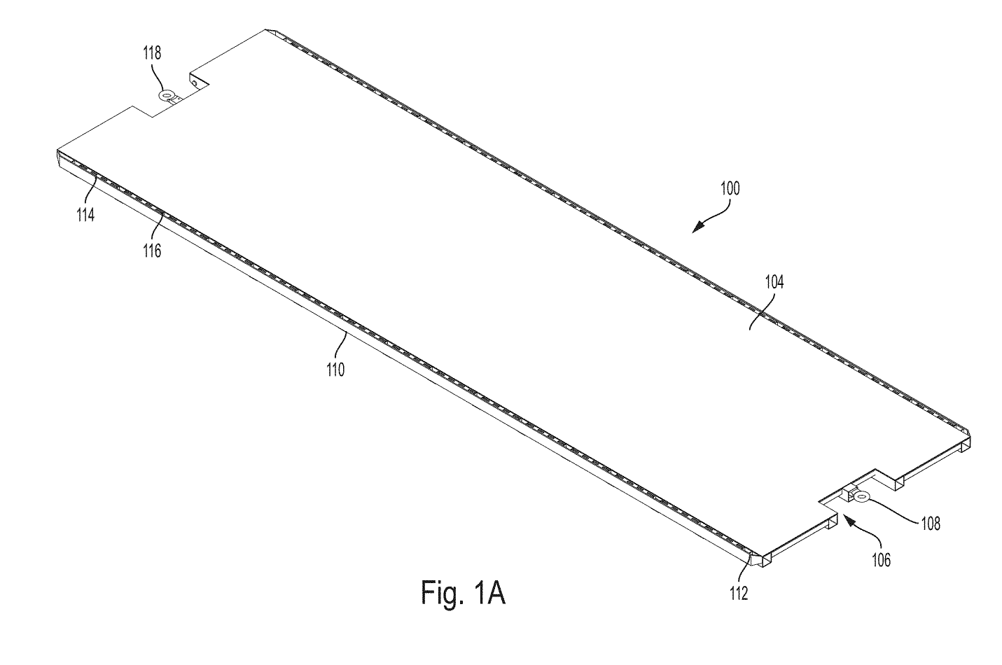

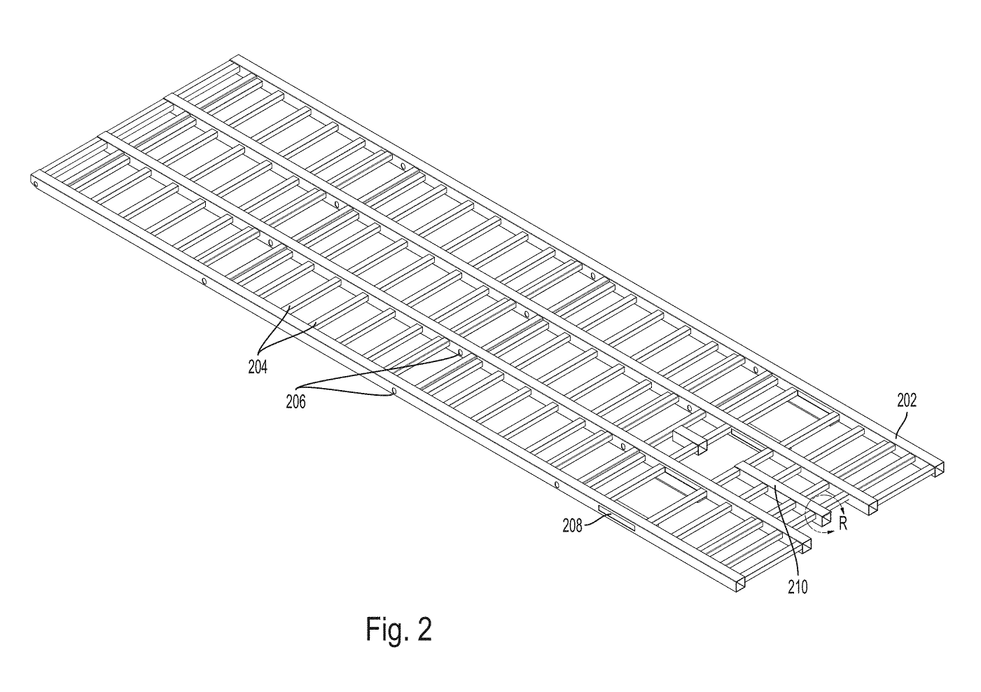

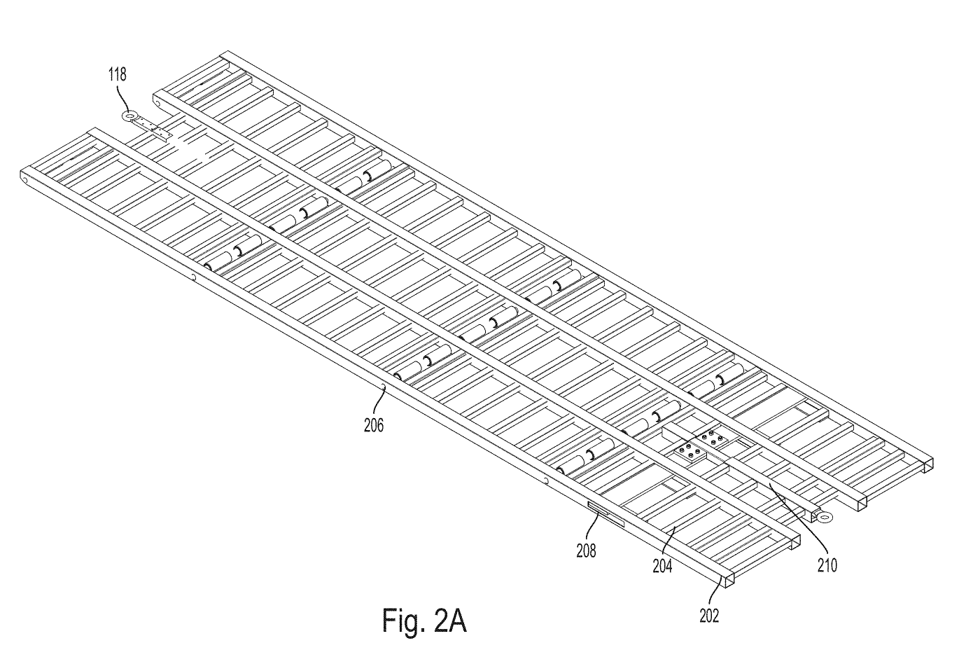

FIG. 2 depicts a perspective view of the frame 102 shown in isolation without decking 104 or mechanical actuation assembly 106. As depicted in FIG. 2, frame 102 generally comprises four lengthwise members 202 and a plurality of smaller cross members 204. Detail R shows the male portion of the detente that allows the drawbar to lock in place when fully extended to prevent it from moving by applying a vertical force.

Holes 206 are located at fixed distances along lengthwise members 204 for receiving the roller axles as will be depicted later. Holes 206 are sized so that the roller axle can be moved upward/downward to engage the roller assemblies. Each lengthwise member 204 also comprises slot 208 which allows mechanical actuation assembly 106 to be moved from a first position to a second position to engage the roller assemblies. The proximal end of body 102 (near lunette eye 108) comprises tubular member 210 through which lunette eye 108 is attached to mechanical actuation assembly 106.

FIG. 2A depicts a perspective view of the frame of MP 100 of FIG. 1A in isolation. The only difference is that the fixed rear roller assembly do not extend across MP 100 because of the addition of lunette eye 118 to MP 100.

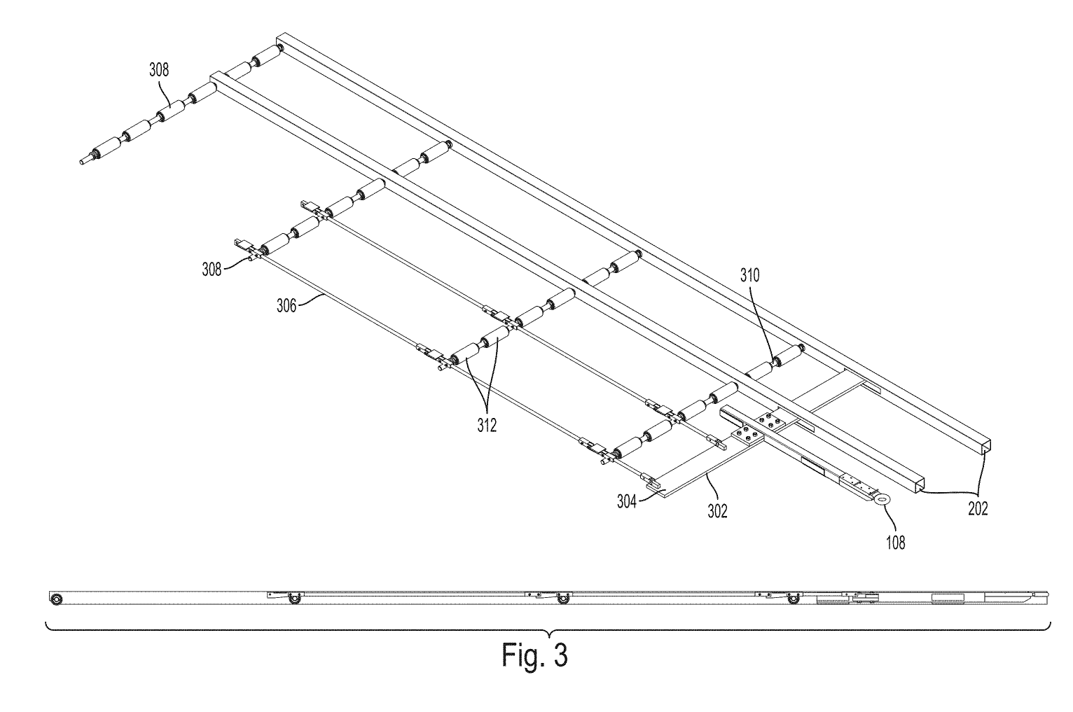

FIG. 3 depicts a perspective view of the mechanical actuation assembly 106 within a cutaway portion of frame 102. Mechanical actuation assembly 106 generally comprises drawbar 302, connection plate 304, ramp guide 306, and roller assembly 308. The roller assembly 308 located at a rear end of movable platform 100 are fixed and do not extend/retract. However, it should be apparent that the rear roller assembly 308 could be attached to mechanical actuation assembly 108 by further extending ramp guide 306 to the rear roller assembly 308.

Drawbar 302 terminates with lunette 108 and extends through tubular member 210. At the distal end, drawbar 302 is connected to connection plate 304 which extends perpendicular to drawbar 302 through slots 208. Ramp guides 306 extend from connection plate 304 through the interior of each lengthwise member 202. Each roller assembly 308 comprises an axle 310 which passes through a plurality of rollers 312 and through holes 206. Each roller 312 is able to rotate independently on axle 310. Preferably, each axle 310 contains at least six rollers 312, with two rollers 312 located between each lengthwise member 202 as depicted in FIG. 3.

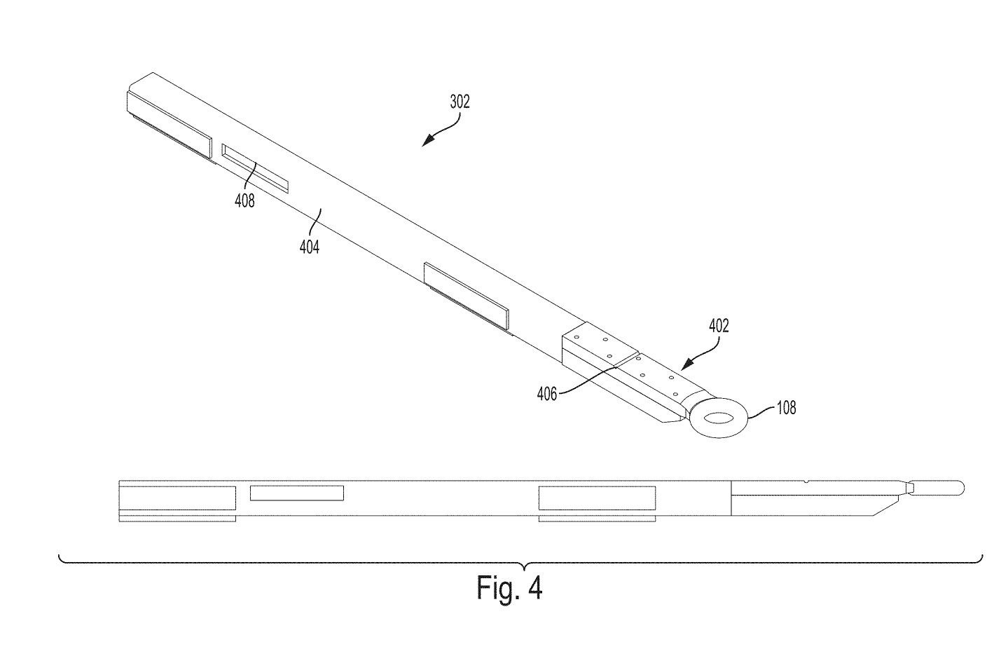

FIG. 4 depicts various views of drawbar 302. Drawbar 302 generally comprises lunette eye 108, drawbar support 402, and shaft 404. Drawbar support 402 connects lunette eye 108 to shaft 404 through any known means (e.g., welding, bolting, etc.). Preferably drawbar support 402 contains slot 406 which mates with a protrusion within tubular member 210 to maintain mechanical actuation assembly 106 in an engaged position as will be described later. Opening 408 is utilized to connect drawbar 408 to connection plate 304.

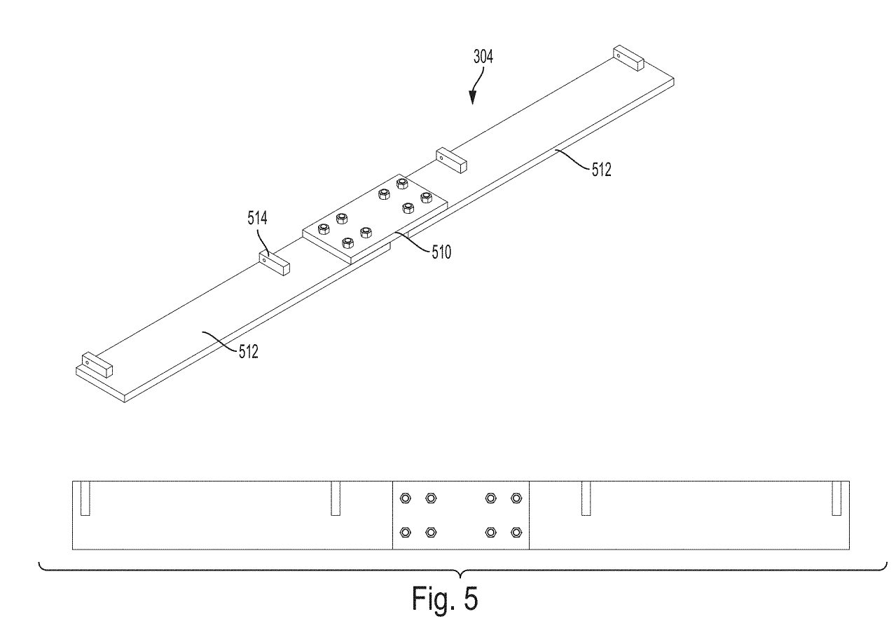

FIG. 5 depicts various views of the connection plate 304 in isolation. Connection plate 304 generally comprises drawplate connector 510, plates 512, and ramp guide connectors 514. Opening 408 in drawbar 302 is centered over drawplate connector 510 and provides a mechanical connection between drawbar 302 and connection plate 304. Further, the four ramp guide connectors 514 are utilized to connect the four ramp guides 306 to connection plate 304.

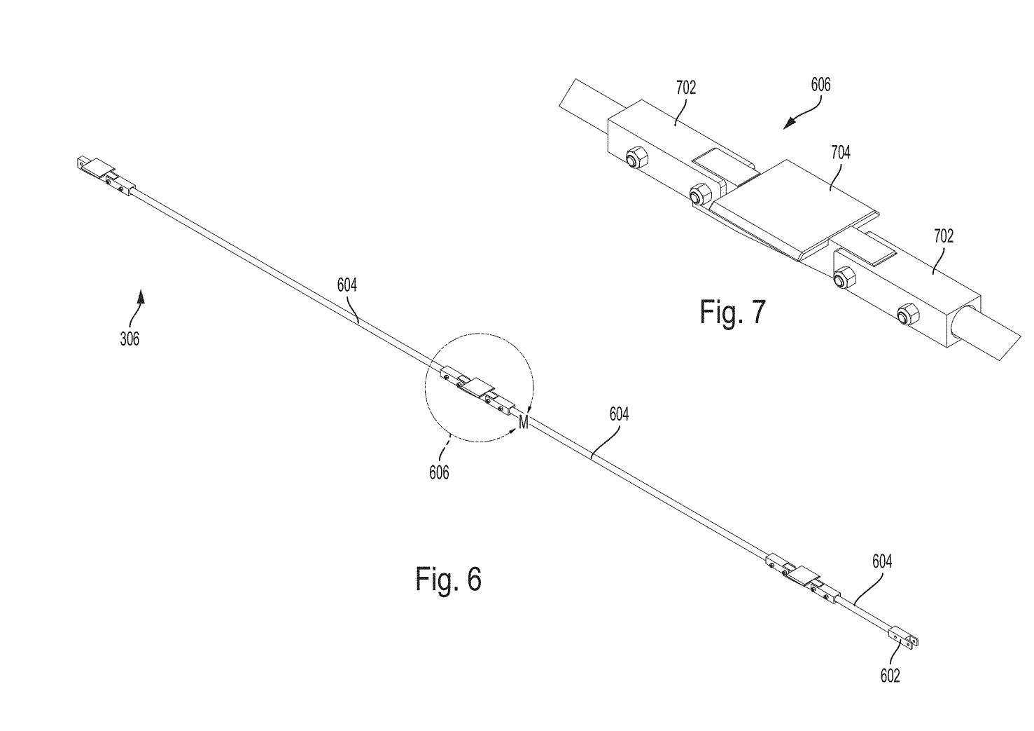

FIG. 6 depicts a perspective view of a single ramp guide 306 in isolation. Each ramp guide 306 generally comprises ramp coupler 602, tie rods 604, and ramp block 606 Ramp coupler 602 connects ramp guide 306 to ramp guide connector 514 on connection plate 304. Ramp blocks 606 are connected together by tie rods 604.

Ramp blocks 606, depicted in greater detail in FIG. 7, provide the downward mechanical force on axle 310 as will be explained in the following drawing. Each ramp block 606 comprises two ramp connectors 702 and ramp 704. A top portion of ramp 704 is flat while a bottom surface of ramp 706 is angled with a flat section to support the axle 310.

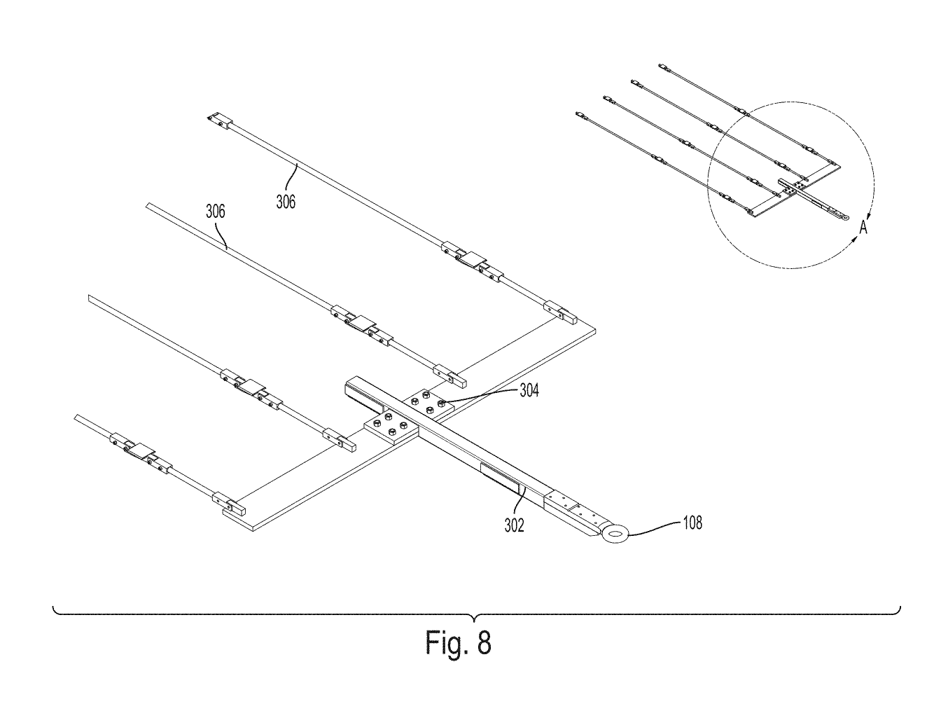

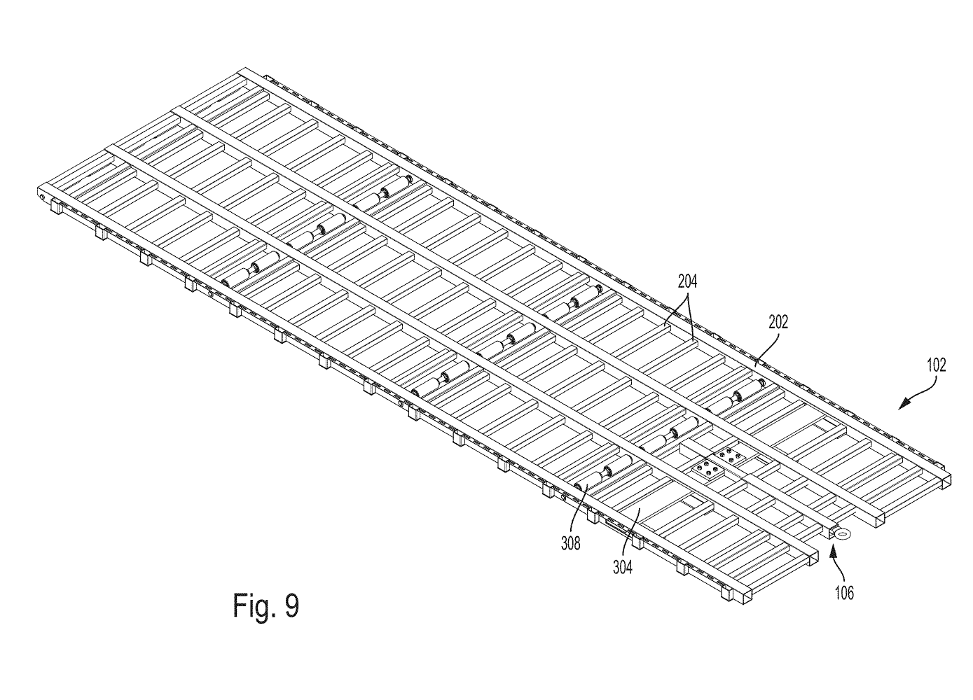

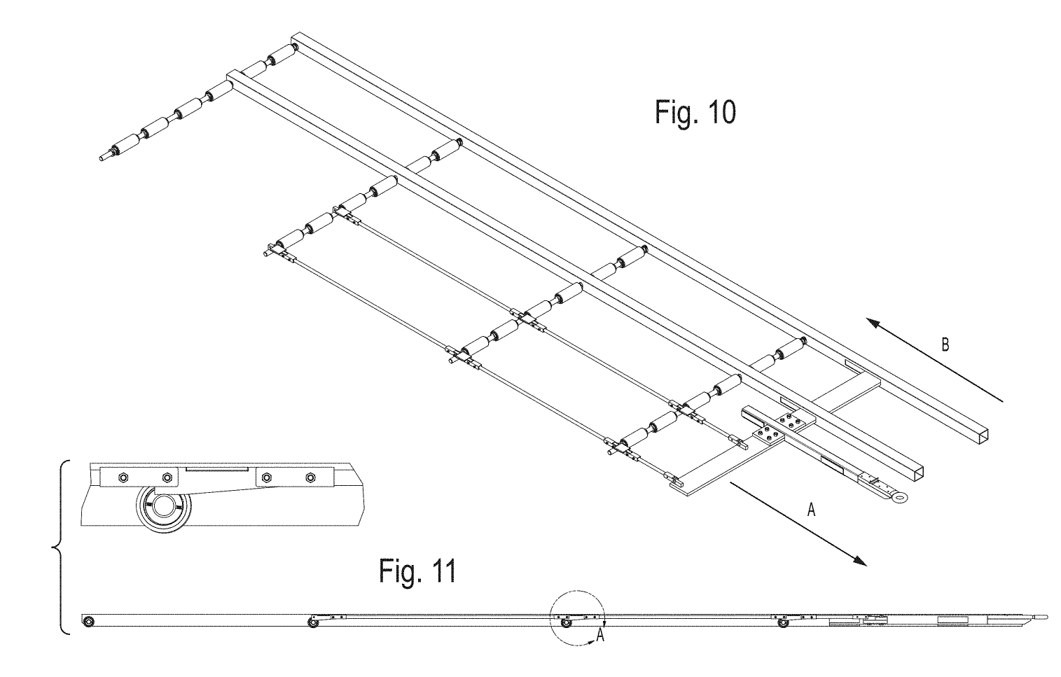

FIG. 8 depicts a view showing the connection between drawbar 302, connection plate 304, and connection plates 306 of mechanical actuation assembly 106. FIG. 9 depicts a perspective view of MP 100 with the decking removed 104 to show mechanical actuation assembly 106 fully contained within frame 102. FIG. 9 depicts a view of MP 100 after mechanical actuation assembly 106 has been moved from a retracted position (FIG. 3) to an engaged position. As shown, connection plate 304 is moved from a rear portion of slot 208 to a front portion. The width of slot 208 limits the movement of mechanical actual assembly 106. As already described, mechanical actuation assembly 106 is moved to the engaged position by extending a force on lunette eye 108 in the direction of arrow A. This causes the angled bottom of ramp 704 to exert a downward force on axles 310, thus lowering rollers 312 (FIG. 11) and/or raising MP 100. The axles 310 rest on a flat section of the ramp as shown in detail A of FIG. 3—Rollers Engaged. After slot 406 engages with the protrusion in tubular member 210 (as shown in Detail R in FIG. 2), the lateral force does not need to be maintained when a vertical force is applied using the forklift attachment 1200 and the mechanical actuation assembly 106 will be maintained in the engaged position. The mechanical actuation assembly 106 can be placed back into the retracted position by removing the vertical force applied by the forklift attachment on the lunette eye 108. This causes the protrusion to be disengaged from slot 406 and the wedges can be disengaged by applying a lateral force in direction B by the forklift attachment on the lunette eye 108 resulting in the axles 310 raising and in turn lowering the platform 102 frame to the ground.

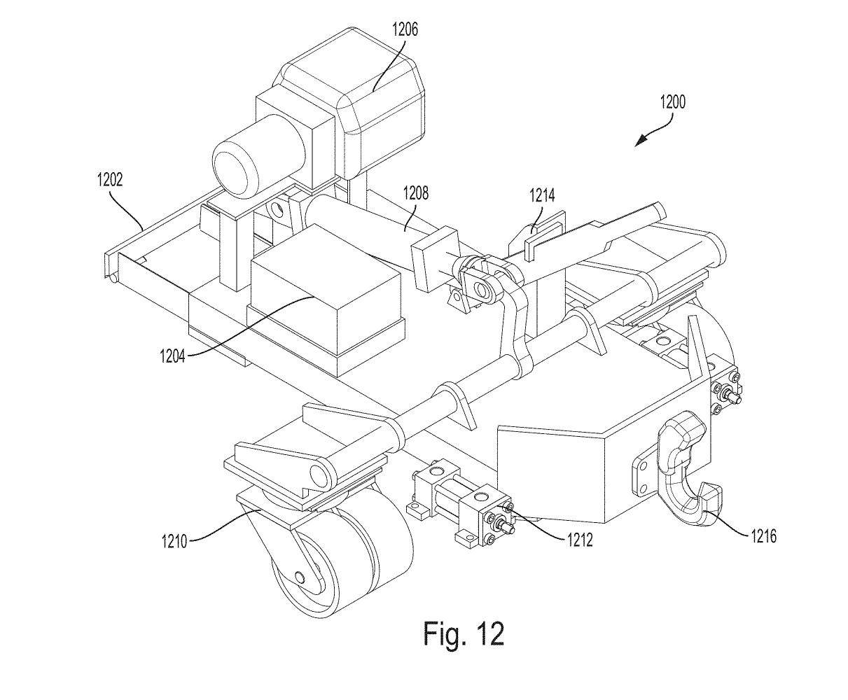

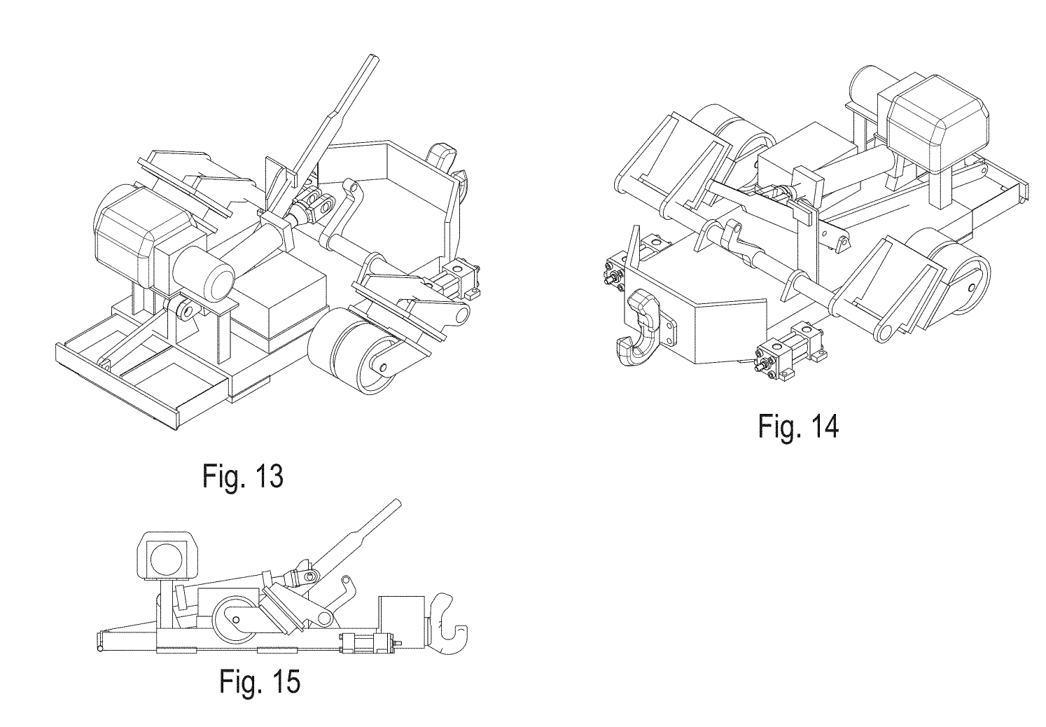

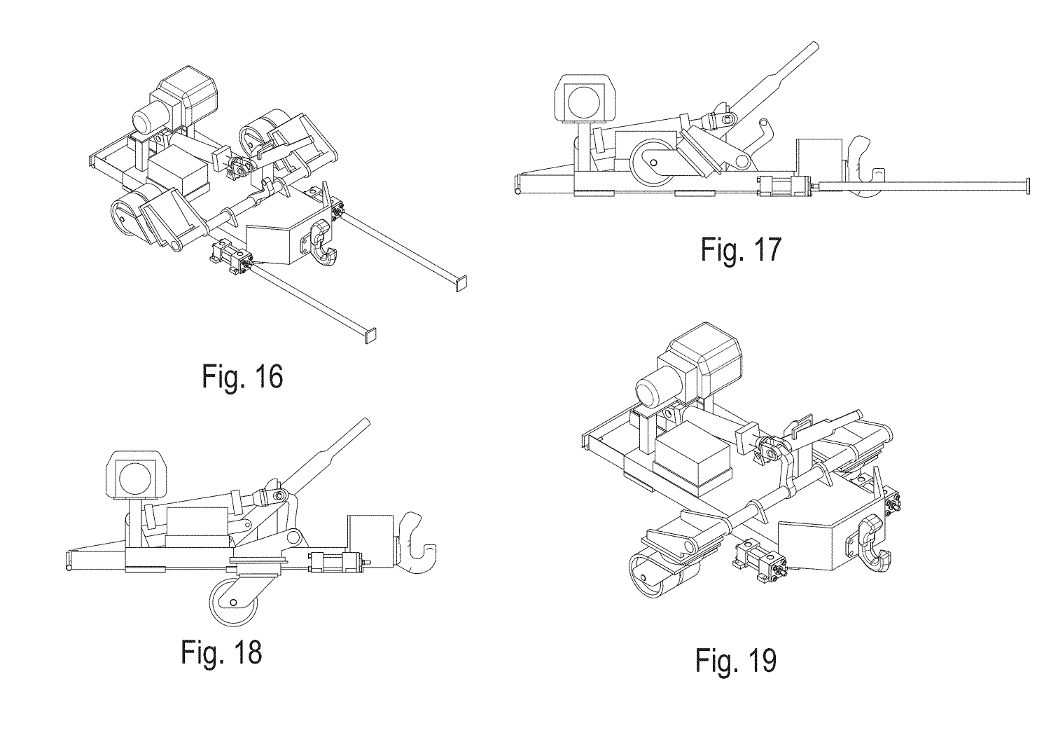

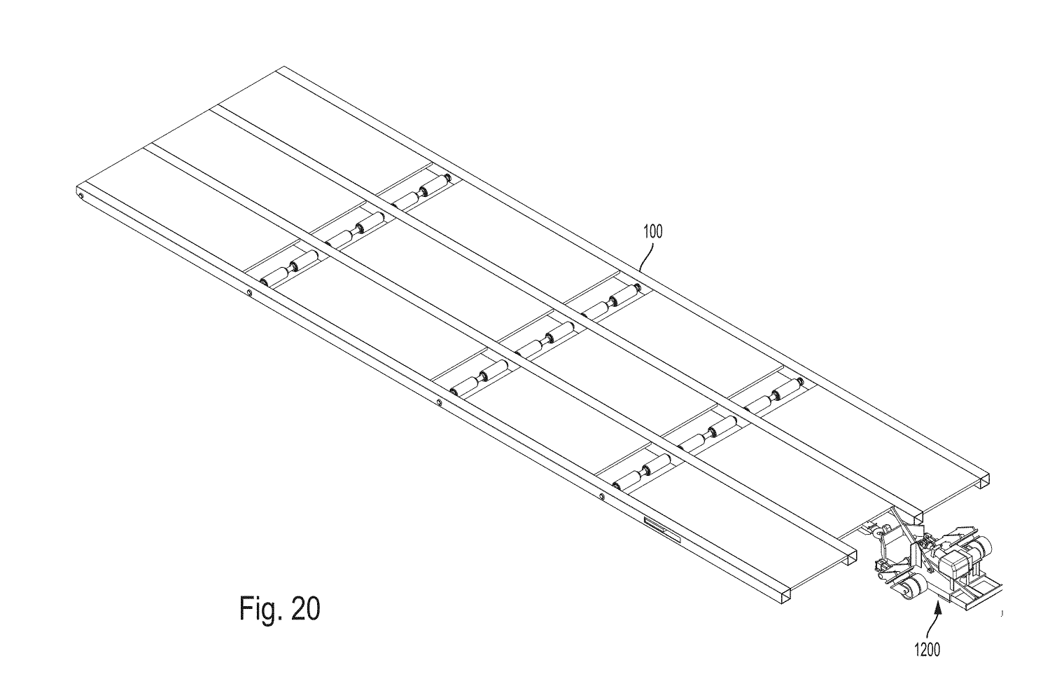

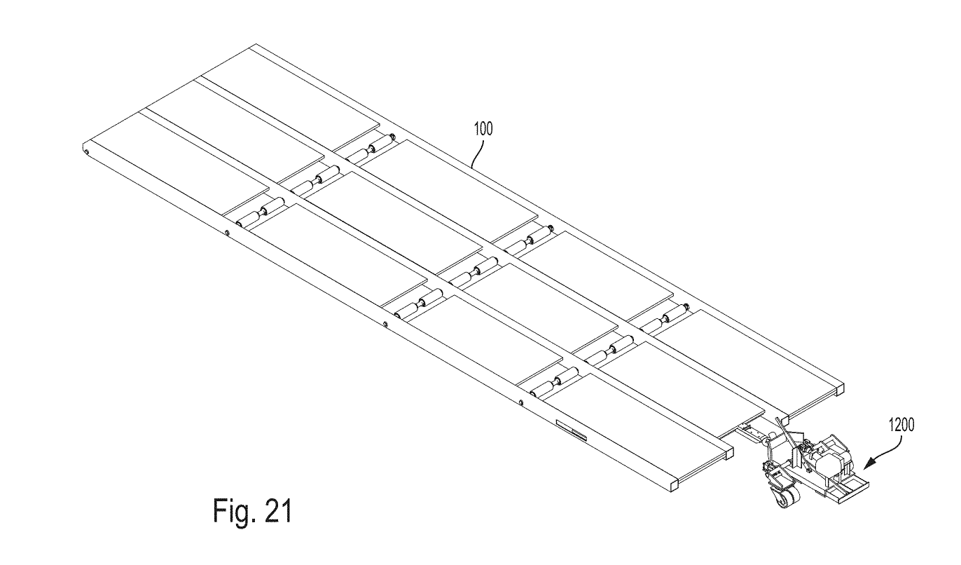

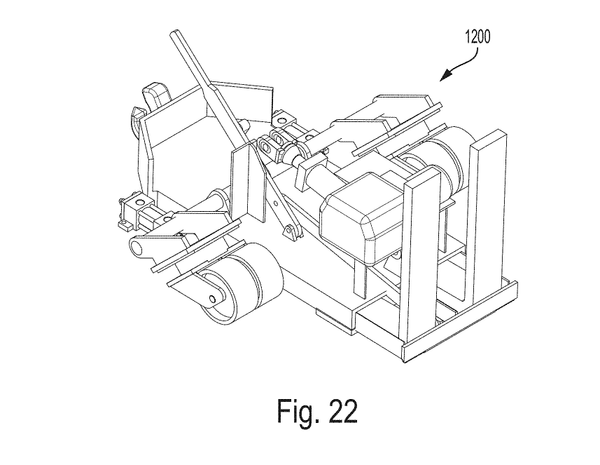

FIGS. 12-15 depicts a perspective view of a forklift attachment 1200 which can be used to (a) move mechanical action assembly 106 to an engaged and disengaged position and (b) decrease the turning radius and increase the maneuverability of MP 100 during conveyance. As depicted, forklift attachment 1200 generally comprises forklift connection 1202, power supply 1204, hydraulic power unit 1206, caster hydraulic cylinder 1208, casters 1210, push and pull arms 1212, locking mechanism 1214, and pintle hook 1216. Hydraulic power unit 1206, powered by power supply 1204, drives both caster hydraulic cylinder 1208 and push and pull arms 1212. Power supply 1204 can either be a battery or a power supply connection from an external source, such as the forklift. Pintle hook 1216 is first engaged with lunette eye 108 by maneuvering forklift attachment 1200 until the two interlock (FIG. 20). Then, to actuate mechanical actuation assembly 106, the push and pull arms 1212 are extended as depicted in FIGS. 16 and 17. This causes a pulling force to be exerted on lunette eye 108 and locks mechanical actuation assembly 106 in the engaged position (FIG. 11). Next, caster hydraulic cylinder 1208 can be extended, causing casters 1210 to pivot downward as depicted in FIGS. 18 and 19. This causes the front end of MP 100 to become slightly raised and casters 1210 can be used to turn MP 100 more easily. At this point, a fully loaded MP 100 can easily be conveyed to/from a trailer or around a warehouse by a standard 4,000 pound and to allow for removing/inserting MP 100 out of an uneven (not level with dock) trailer.

For lighter loads on MP 100, only the casters 1210 need to be extended and the MP 100 can be moved around similar to a wheelbarrow. Further, instead of push and pull arms 1212, other actuating means, such as a leadscrew or internal hydraulics, may be utilized.

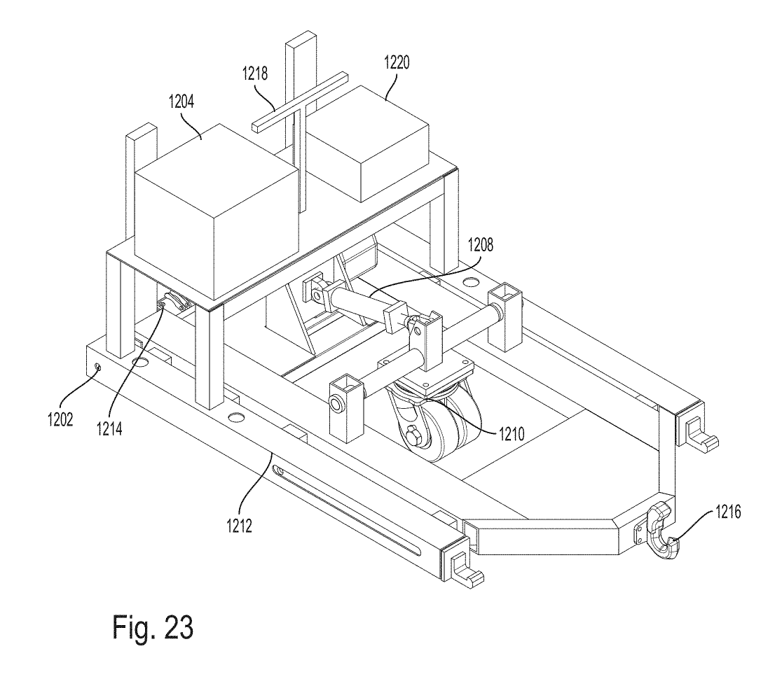

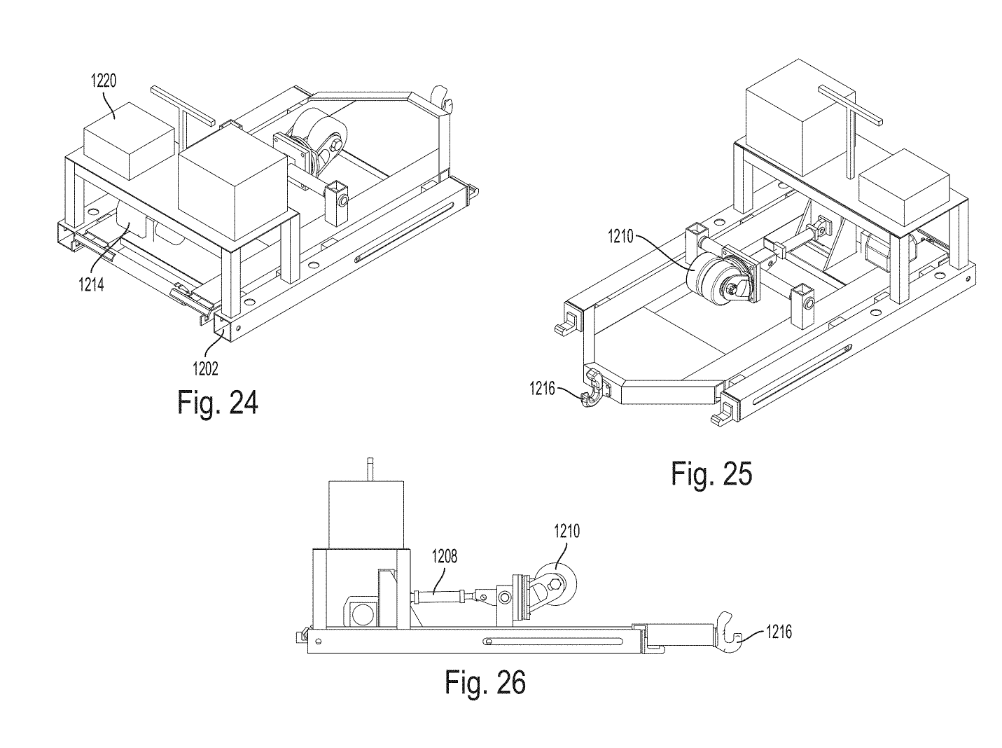

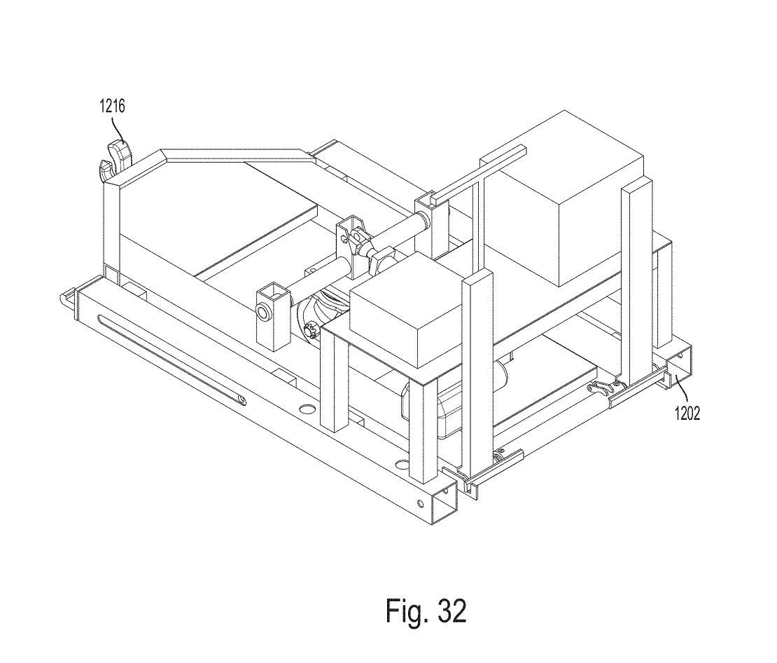

FIGS. 23-32 depict an alternate embodiment of forklift attachment 1200. As depicted in FIG. 23, forklift attachment 1200 generally comprises forklift connection 1202, power supply 1204, hydraulic power unit 1206, caster hydraulic cylinder 1208, swivel caster 1210, push and pull arms 1212, locking mechanism 1214, pintle hook 1216, guide lights 1218, and control box 1220. Hydraulic power unit 1206, powered by power supply 1204, drives both caster hydraulic cylinder 1208 and push/pull arms 1212. In this embodiment, push/pull arms 1212 contained within the frame of forklift attachment 1200.

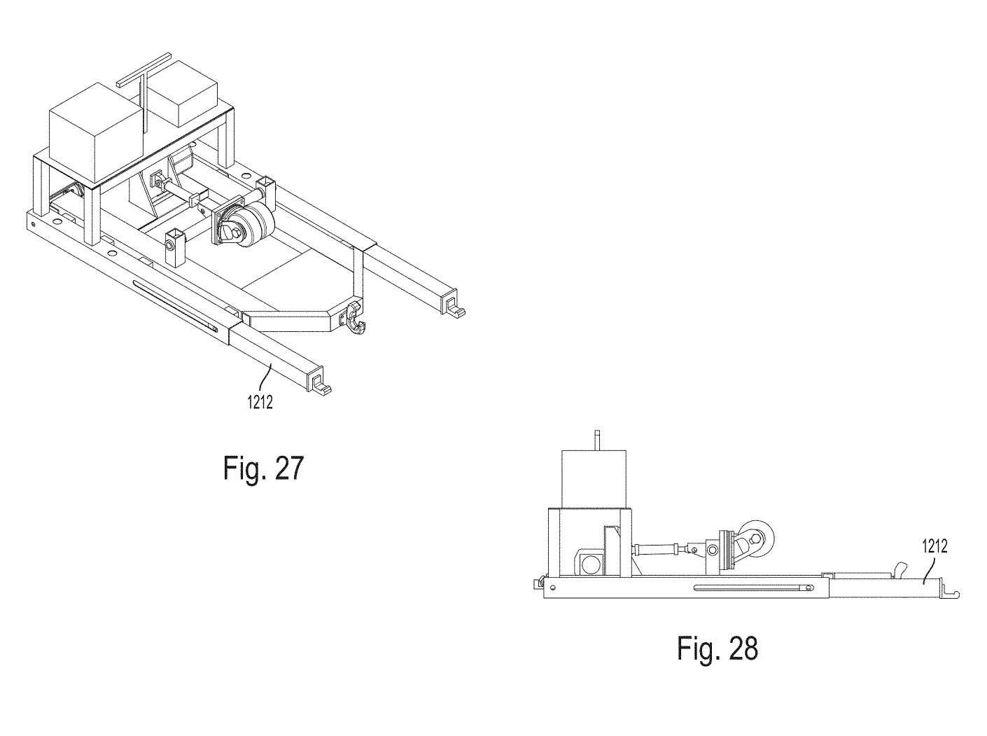

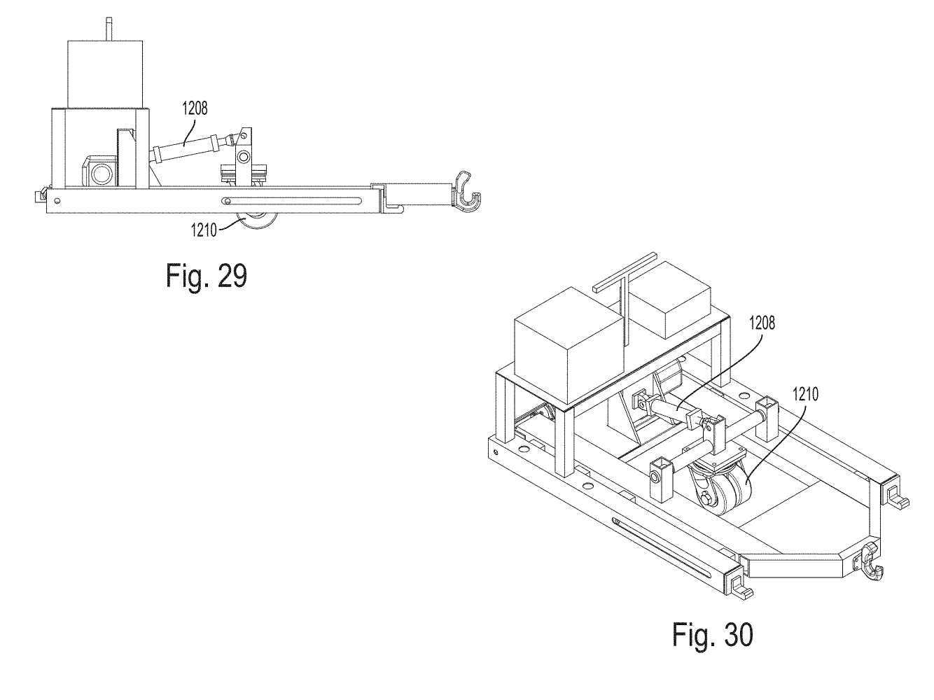

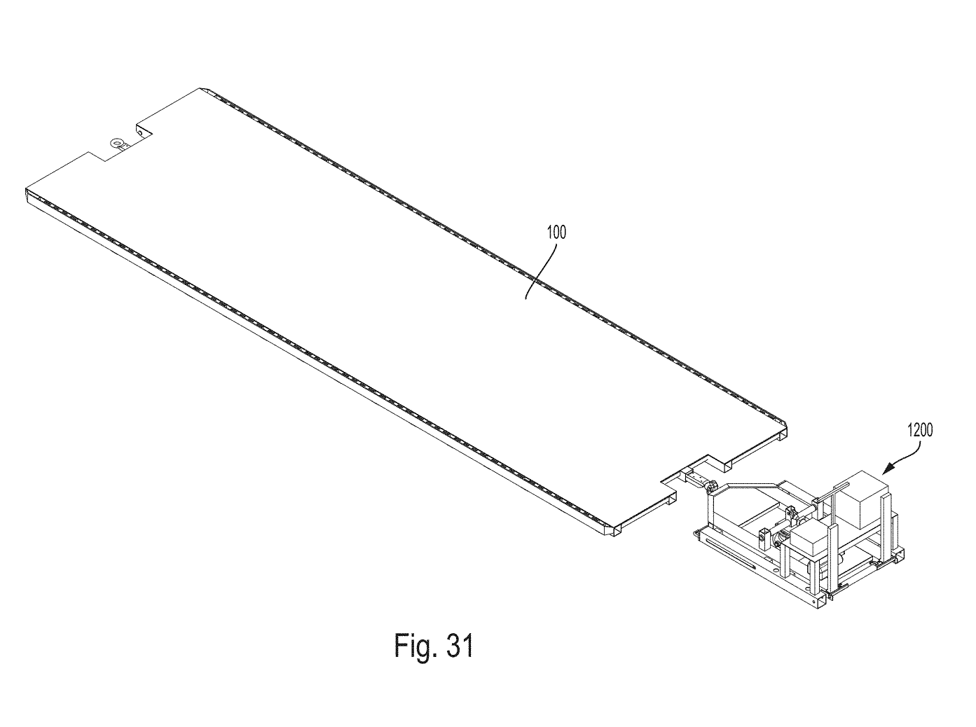

Power supply 1204 can either be a battery or a power supply connection from an external source, such as the forklift. Pintle hook 1216 is first engaged with lunette eye 108 by maneuvering forklift attachment 1200 until the two interlock (FIG. 31). Then, to actuate mechanical actuation assembly 106, the push/pull arms 1212 are extended as depicted in FIGS. 27 and 28. This causes a pulling force to be exerted on lunette eye 108 and locks mechanical actuation assembly 106 in the engaged position (FIG. 11). Next, caster hydraulic cylinder 1208 can be extended, causing swivel caster 1210 to pivot downward as depicted in FIGS. 29 and 30. This causes the front end of MP 100 to become slightly raised and swivel caster 1210 can be used to turn MP 100 more easily. In this embodiment, swivel caster 1210 provides an increased turning radius because the single swivel caster 1210 can rotate in any direction.

At this point, a fully loaded. MP 100 can easily be conveyed to/from a trailer or around a warehouse by a standard 4,000 pound forklift and to allow for removing/inserting MP 100 out of an uneven (not level with dock) trailer.

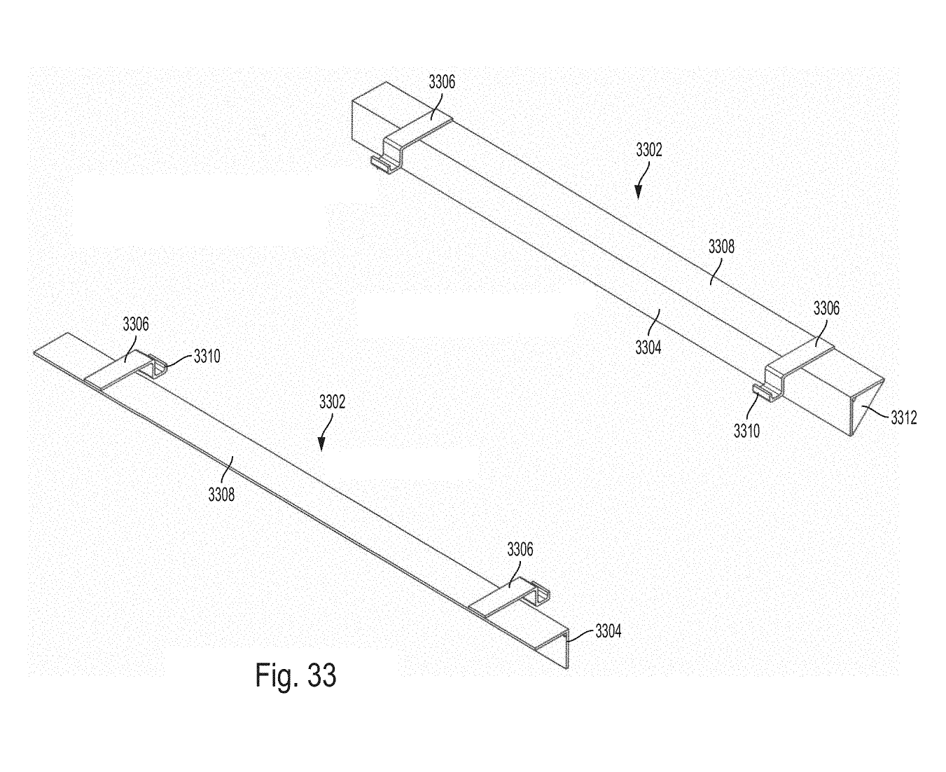

In some situations it may be desirable for an MP 100 designed to fit in a narrower roll door trailer, that is 92″ wide, to also fit into a swing door trailer, that is 96″ wide. While this is certainly possible given the narrower width of a 92″ MP 100, the available loading capacity is reduced by 4″. In those situations where the additional width is desired, extensions made be installed on the sides of the MP 100 to obtain the additional 4″ of loading capacity. FIGS. 33-38 show four different versions of possible extensions for MP 100.

FIG. 33 shows a clip-on extension 3302 that clips into the e-slot cutouts 114 (See FIG. 1) on the rub rail 110. Generally, the -slot cutouts 114 are regularly spaced rectangular slots located on the top or side surface of rub rail 100. In some embodiments, the e-slot cutouts 114 may be reinforced to support extra freight loaded onto clip-on extensions 3302.

Each clip-on extension 3302 is preferably triangular in cross-section as depicted in FIG. 33. A rub rail side 3304 rests against rub rail 110 when clip-on extension 3302 is attached to MP 100. A plurality of clips 3306 are welded to a top surface 3308 of clip-on extension 3302. Each clip 3306 comprises a hook 3310 which interfaces with an e-slot cutout 114. As previously described, the e-slot cutouts 114 may be reinforced and provided with a downward projecting member which allows clips 3306 to hook into the e-slot cutouts 114. One or more gussets 3312 are welded to the side of rub rail side 3304 and the bottom of top surface 3308 to provide structural support.

The clip-on extensions 3302 may be manufactured in any desired length. For example, each clip-on extension 3302 may extend the entire length of MP 100 to allow each side of MP 100 to be extended by 2″ (or more). In other embodiments, clip-on extension 3302 may be a fraction of the length of MP 100 (¼ length or ½ length), thereby allowing easier installation (i.e., by hand). Fractional length clip-on extensions 3302 are also useful when only a certain portion of MP 100 needs to be extended to accommodate odd-shaped freight or freight that may need extra support.

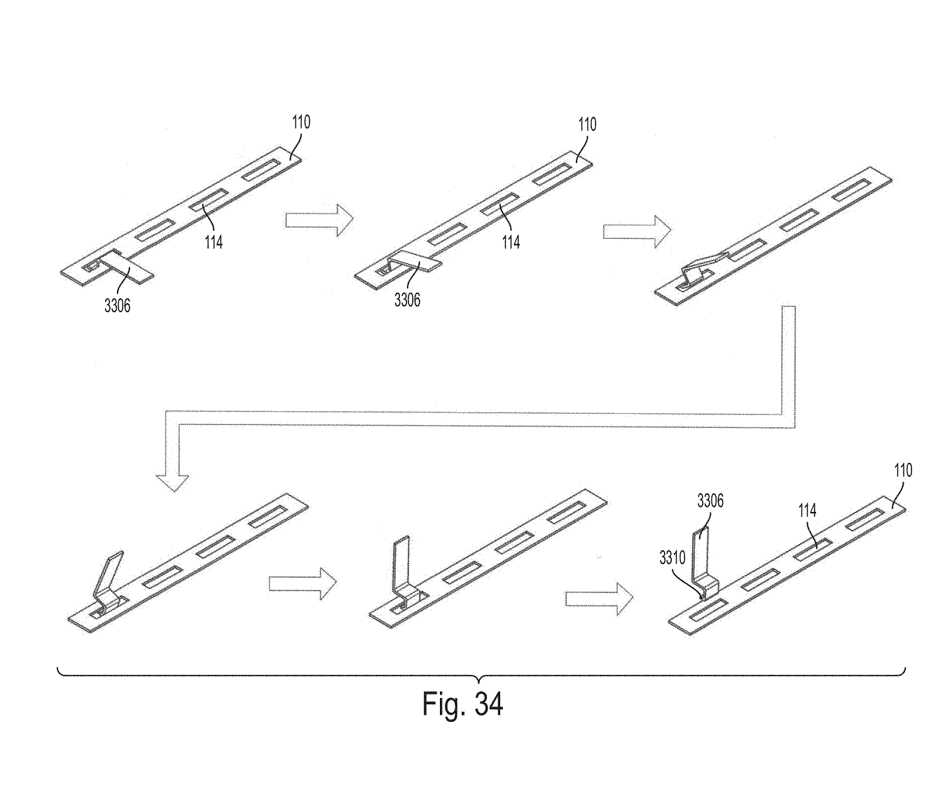

Clips 3306 allow for quick assembly/disassembly of the clip-on extensions 3302. FIG. 34 shows the clip-on assemble/disassembly process. As depicted, each clip-on extension 3302 is tilted upwards towards rub rail 110 until clips 3306 disengage from e-slot cutouts 114, thereby allowing clip-on extension 3302 to be removed from MP 100.

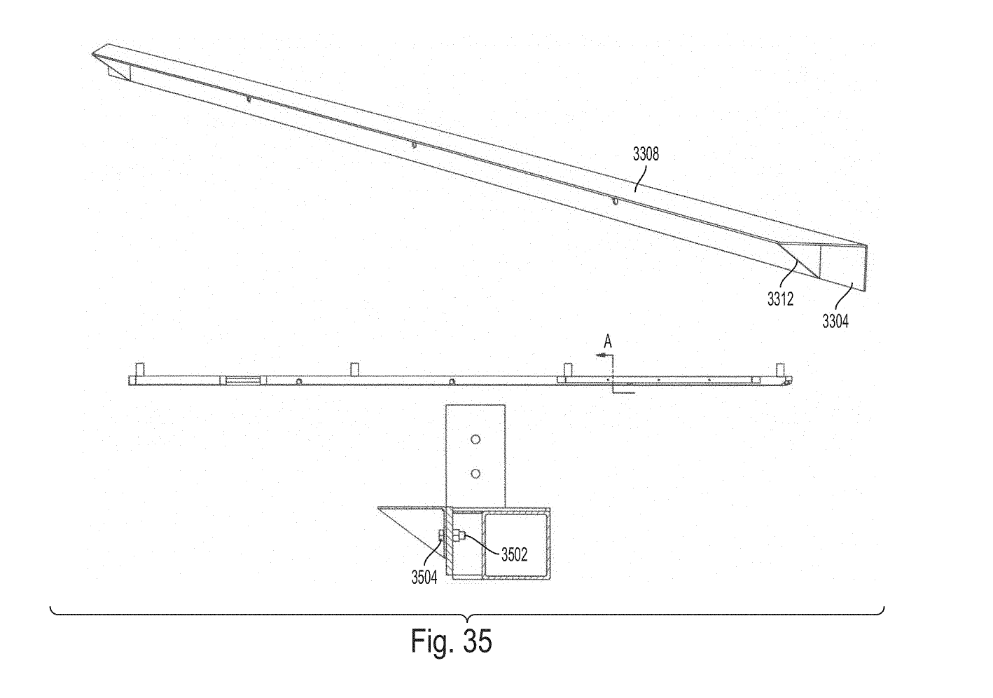

FIG. 35 shows a bolt-on version of the extensions 3302 that would bolt on the rub rail 110 via a nut and bolt and clearance holes cut through rub rail side 3304 and rub rail 110. In this embodiment, no clips 3306 are provided. Otherwise, the construction of extension 3302 depicted in FIG. 35. In this embodiment, e-slot cutouts 114 provide access to the inside of rub rail 114 to allow nuts 3502 to be held in place (e.g., using a wrench as bolts 3504 are tightened).

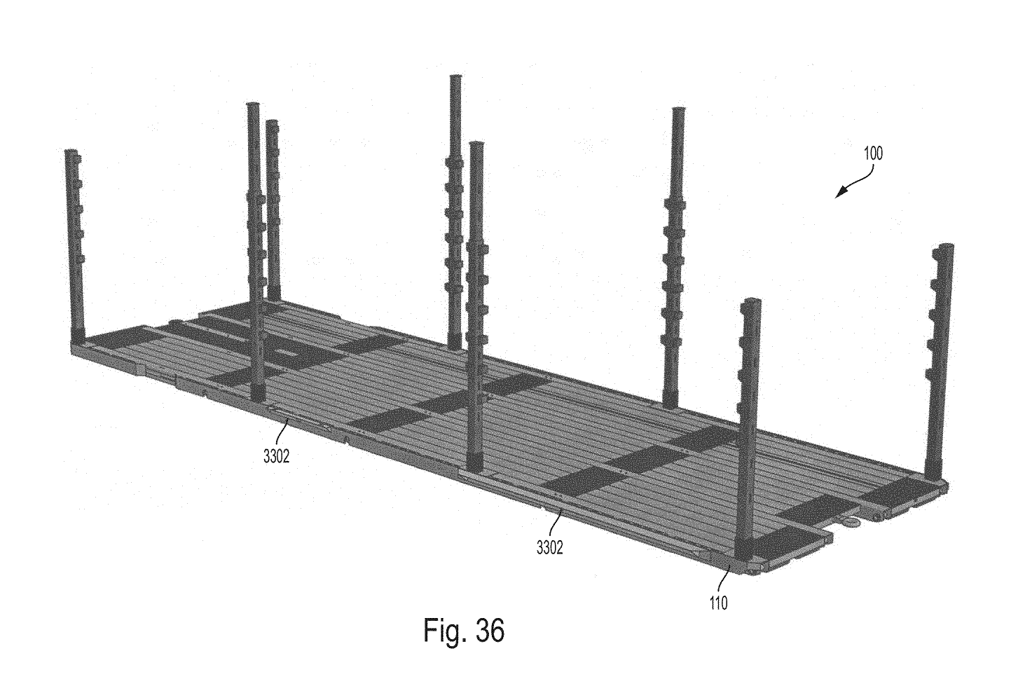

FIG. 36 shows a perspective of the MP 100 with a clip-on extension 3302 and a bolt-on extension 3302. These can be utilized interchangeably on the MP 100, however, in most circumstances one design or the other will be chosen for sole use on the MP 100.

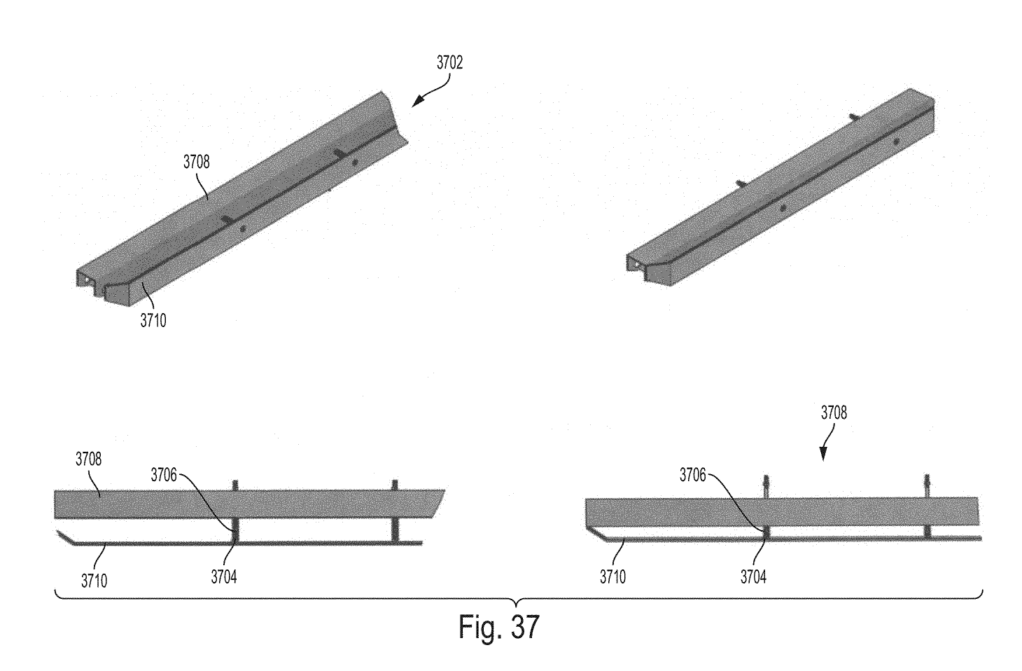

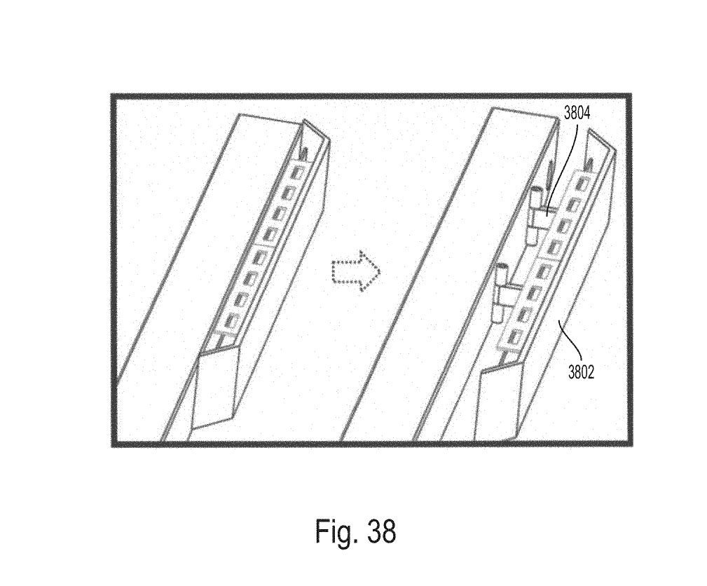

FIG. 37 shows an alternative extension concept of a compressible spring extension rub rail 3702. In this embodiment, the entire rub rail 110 is replaced with extension rub rail 3702. The swing extension rub rail 3702 comprises connections bolts 3704, compression springs 3706, beam nuts, rub rail nuts, inner rub rail 3708, and outer rub rail 3710. Beam nuts and rub rail nuts are used to attach inner rub rail 3708 to lengthwise members 202 in a similar fashion to bolt-on extension 3302 (through holes provided in both elements).

The spring extension rub rail 3702 allows the MP 100 to have an extended width of 96″ and a compressed width of 92″ when conveyed into a narrower trailer. Inner rub rail 3708 is made of steel for rigidity and strength, and an outer rub rail 3710 is made of plastic which lowers the friction between the trailer and MP 100 in order to prevent damage when conveying into and out of the trailer. The connection bolts 3704 inner rub rail 3808 to outer rub rail 3710. Compression springs 3706 are placed on the connection bolts 3704 allowing the outer rub rail 3710 rail to expand and collapse.

FIG. 38 shows an alternate embodiment showing a hinged rub rail 3802 which can be used in substitution of rub rail 110. In this embodiment, hinged rub rail 3802 is attached to lengthwise members 202 via a plurality of horizontal hinges 3804 mounted on the outside edge of the lengthwise members 202. The other side of the hinge 3804 is mounted to hinged rub rail 3802 and allows it to extend and collapse. When in the collapsed state, the width of the MP 100 is preferably 92″. When at the extended state, the width of the MP 100 is preferably 96″. The hinged rub rail 3802 may extend the entire length of MP 100, allowing the entire width to be expanded, or the hinged rub rail 3802 may be section to allow different portions of hinged nib rail 3802 to be extended as needed.

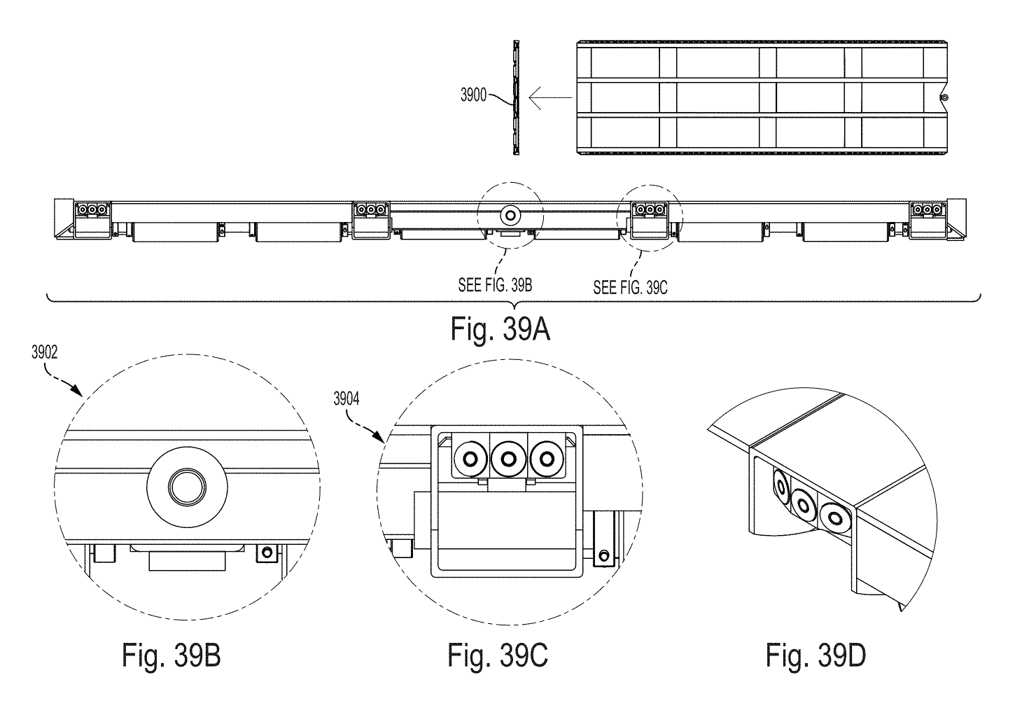

FIG. 39 depicts the Mobile Platform Collision Avoidance (MPCA) sensing system 3900. As shown in FIG. 34, the MPCA sensing system 3900 is composed of camera 3902 and proximity sensors 3904. Proximity sensors 3904 may be any type of sensor capable of detecting collisions such as inductive, capacitive, photoelectric and ultrasonic. The MPCA sensing system 3900 is located opposite the forklift and attachment end of MP 100. The purpose of the MPCA sensing system 3900 is to collect data such as, but not limited, to video, proximity of nearby objects and relay that information to the opposite end of the platform (e.g., to the forklift driver).

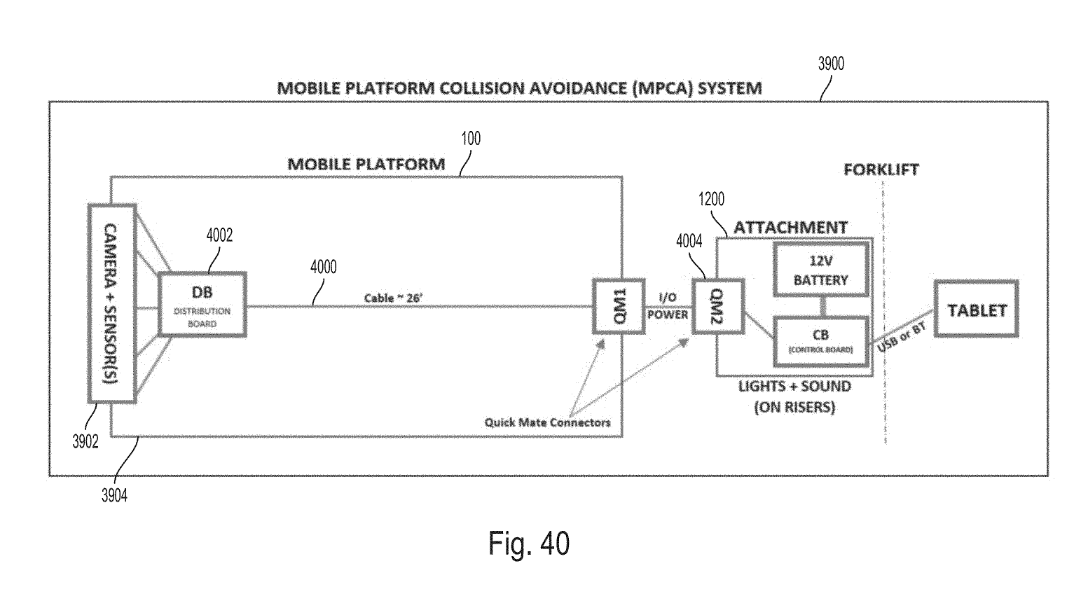

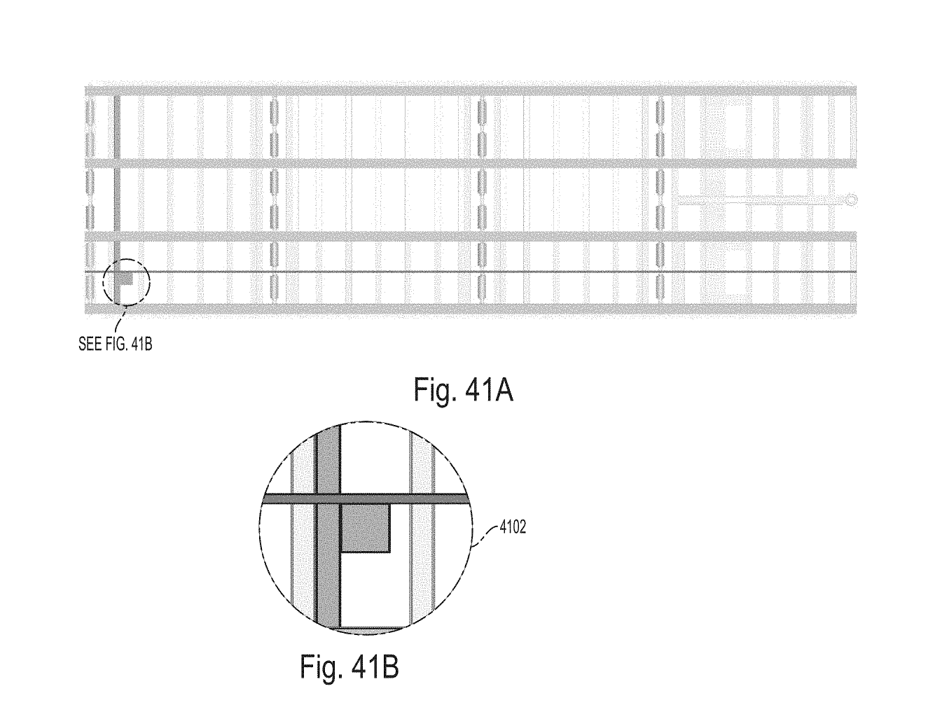

FIG. 40 depicts the wiring conduit 4000 for MPCA sensing system 3900. The wiring conduit 4000 allows for wires to run from both ends of MP 100. FIGS. 41A and 41B depict junction box 4102 located on MP 100. A distribution board 4002 is housed in junction box 4102. Distribution board 3502 allows for easy connections of camera 3902 and sensors 3904 to a main cable running the length of MP 100 as depicted in FIG. 41A.

Quick mate (QM) connectors 3404 allow for snap connection between forklift attachment 1200 and MP 100. QM connectors 4004 transfer data, video and power from MP 100 via distribution board 4002 to the control box 1220 on forklift attachment 1200. The snap connection action is obtained via magnets but is not limited to just magnets, other mechanical options can produce such results.

Visual and auditory cues are outputted via high power LEDs (guide lights 1218) and speaker(s) on risers on forklift attachment 1200. A direct correlation between the proximity of objects is made to the sound and visuals of the lights outputted.

Control board (CB) works as the brain of the MPGA. The CB interprets input signals such as sensor data, voltage, camera, etc. Following the inputs, the CB analyzes these inputs by using stored algorithms and makes decisions as to what the proper outputs for the sounds and lights should be. Furthermore, the CB transfer video and sensor data to a tablet mounted on a forklift via a wireless and/or USB connection.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A movable platform comprising:
an exterior frame;
a plurality of roller assemblies attached to the exterior frame;
at least two rub rails attached to opposing sides of the exterior frame,
wherein the at least two rub rails comprise a plurality of rectangular openings along a length of the rub rails; and
an extension assembly comprising a plurality of clips along a length of the extension assembly,
wherein the clips are adapted to be releasably inserted into the rectangular openings to extend a width of the movable platform.

2. A movable platform comprising:
an exterior frame;
a plurality of roller assemblies attached to the exterior frame;
at least two rub rails attached to opposing sides of the exterior frame,
wherein each rub rail is movable between an extended position and a collapsed position.
